(19) United States
(12) Patent Application Publication
(10) Pub. No.: US 2008/0184204 A1
(43) Pub. Date: Jul. 31, 2008

(54) Dynamic validation using reflection

(75) Inventors: James Jordan Tigani, Seattle, WA (US); Harsh Jitendrakumar Shah, Redmond, WA (US); Huy Vu-Bao Hoang, Bellevue, WA (US); David James Matsumoto, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/700,275

(22) Filed: Jan. 31, 2007

(51) Int. Cl. G06F 9/44

(52) U.S. Cl. 717/126

(57) ABSTRACT

The behavioral or structural characteristics of an object to be validated, such as a software object or a data object, are dynamically identified using reflection. Once the behavioral or structural characteristics of the object have been obtained using reflection, the identified characteristics are utilized to locate a validator capable of validating the object. The located validator is then executed to validate the object.

### BACKGROUND

Software validation refers to the process of applying a policy to an object to determine whether the object behaves according to one or more expected behavioral characteristics. For instance, a data object may be validated to determine whether the data contained therein is within certain boundaries or constraints. A software object may also be validated to determine whether the software is operating within other boundaries or constraints.

One of the most difficult challenges in software validation is the process of matching the objects to be validated with the proper boundaries or constraints. Current processes for matching objects to boundaries or constraints are very primitive in their strategy, design, and implementation. These processes typically implore hard-coded identification that ties a software validation program to a specific software or data object to be validated. For instance, many software validation programs utilize hard-coded scripts that are created for validating and tied to a particular software or data object. Similarly, software validation programs capable of validating the fields of a world-wide-web (“Web”) page may utilize a software validation program that is hard-coded to specific fields in the Web page.

Hard-coding a software validation program directly to the objects to be validated allows the software validation program to be easily implemented. However, because such software validation programs are tied directly to the programs or data they validate, they are generally not reusable with other programs or data sets. Moreover, when a software validation program is tied directly to the software or data object to be validated, changes to the software or data object can require a corresponding change to the software validation program. These types of shortcomings may limit the reuse of the software validation program, and may require considerable modification of the software validation program as the software or data object being validated changes.

It is with respect to these considerations and others that the disclosure made herein is provided.

### SUMMARY

Technologies are described herein for dynamic validation using reflection. Through aspects presented herein, the structural and behavioral characteristics of an object to be validated may be obtained through reflection. Based upon the obtained structural or behavioral characteristics, an appropriate validator can be selected to validate the object. Because the validator is not tied directly to the object, the validator can be reused to validate other software components.

According to one aspect presented herein, the structural or behavioral characteristics of an object to be validated, such as a software object or a data object, are identified using reflection. Reflection refers to the object-oriented ability of an object to return information regarding its structural or behavioral characteristics, such as its type, methods, or properties. Once the structural or behavioral characteristics of the object have been obtained using reflection, the identified characteristics are utilized to locate a validator capable of validating the object. The located validator is then executed to validate the object.

According to another aspect presented herein, an object having a multitude of sub-components may also be validated dynamically using reflection. In order to validate such an object, the structural or behavioral characteristics of each sub-component are identified using reflection. An appropriate validator for validating the operation of or data contained within each sub-component is then identified using the characteristics obtained through reflection. The validator for each sub-component is then executed to validate the corresponding sub-component. If each sub-component is valid, the object is determined to be valid. If each sub-component is not valid, the object is invalid.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram showing an illustrative software architecture provided in one embodiment described herein;

FIG. 2 is a flow diagram showing one illustrative process for dynamic validation using reflection provided herein; and

FIG. 3 is a computer architecture diagram showing a computer architecture suitable for implementing a computer system capable of dynamic validation using reflection according to one implementation.

### DETAILED DESCRIPTION

The following detailed description is directed to technologies for dynamically validating an object through the use of reflection. As will be discussed in greater detail below, the ability of a software or data object to dynamically identify its structural or behavioral characteristics at runtime can be utilized to identify an appropriate validator for validating the operation of the object. This allows the object to be disconnected from the software that is utilized to validate it. Moreover, the dynamic identification of validators through the use of reflection allows the use of libraries of validators to enforce boundaries and constraints on any new software or data object. Using reflection, an object can be matched to appropriate validators in the library, and thereby have its behavior validated against all of the constraints and boundaries offered by the validators in the library.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

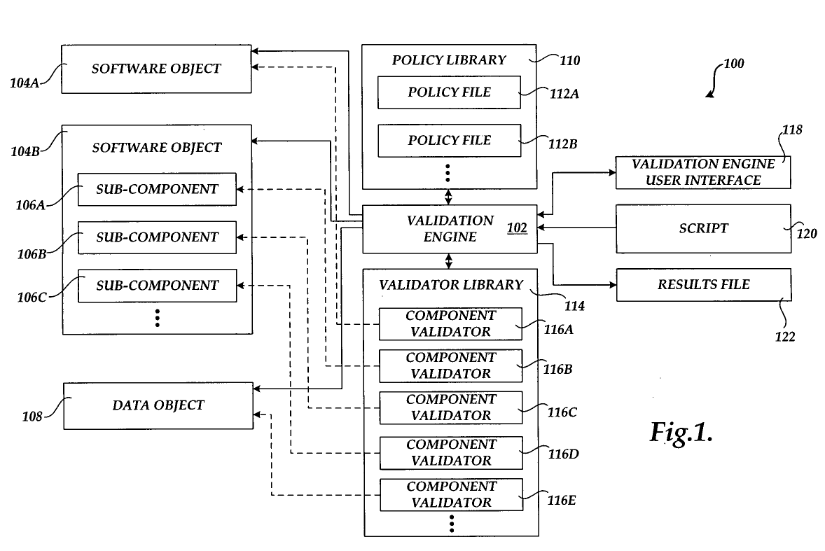

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for dynamically validating an object using reflection will be described. In particular, FIG. 1 is a software architecture diagram showing an illustrative software architecture for dynamically validating an object using reflection according to one implementation.

As shown in FIG. 1, the embodiments presented herein utilize a validation engine 102 to coordinate the process of validating objects. As will be discussed in greater detail herein, the validation engine 102 utilizes the contents of a policy library 110 and a validator library 114 to dynamically validate an object, such as the software objects 104A-104B or a data object 108. A software object 104 is an object that implements one or more classes. A software object may also implement one or more data types. A data object 108 is an object that is utilized primarily to store data. As shown in FIG. 1, a software object 104B may also be composed of one or more sub-components 106A-106C. Each of the sub-components 106A-106C may be a software object or a data object.

As also shown in FIG. 1, the validation engine 102 may be controlled through the use of a validation engine user interface program 118. Alternatively, the validation engine 102 may be executed from a command line and configured utilizing a script 120. When using the user interface program 118, validation results may be presented to a user through a graphical user interface provided by the user interface program 118. When a script 120 is utilized to control the operation of the validation engine 102, the validation engine 102 may write the results of a validation operation to a results file 122.

As will be described in greater detail below, the validation engine 102 utilizes the contents of a policy library 110 and a validator library 114 to validate objects. The policy library 110 includes one or more policy files 112A-112B. The policy files 112A-112B include data that assigns a particular software object 104 or data object 108 to a component validator 116 (also referred to herein as a “validator”). In this regard, each policy file 112 includes data that identifies the component validator 116 that will perform the validation for an identified object along with data that describes the operation of the referenced validator 116. The policy files 112 may be expressed utilizing the extensible markup language (“XML”), other type of markup language, or other type of data structure.

The validator library 114 contains one or more component validators 116A-116E. The component validators 116A-116E are executable software components capable of validating an object or a sub-component of an object. For instance, the component validator 116A is configured to validate the software object 104A, the validators 116B-116D are configured to validate the sub-components 106A-106C, respectively, and the validator 116E is configured to validate the data object 108. It should be appreciated, however, that the validators 116A-116E are reusable software components that are not hard-wired to the objects 104A-104B and 108. Rather, the validators 116A-116E are capable of validating any software component having the same structural or behavioral characteristics as the objects 104A-104B and 108. In this regard, the validator library 114 may be extended through the inclusion of additional component validators 116.

As discussed briefly above, the validation engine 102 utilizes reflection to identify the structural or behavioral characteristics of the object to be validated. Reflection refers to the capability of a software object 104 or data object 108 to self-identify its structural or behavioral characteristics, such as its data types, methods, input and outputs, or properties. Reflection is currently supported in the VISUAL C#® and VISUAL BASIC® .NET programming languages using the .NET FRAMEWORK™ from MICROSOFT® CORPORATION of Redmond, Wash. Reflection is also supported in the JAVA™ programming language from SUN MICROSYSTEMS™ and in the C++ programming language through the use of third-party libraries.

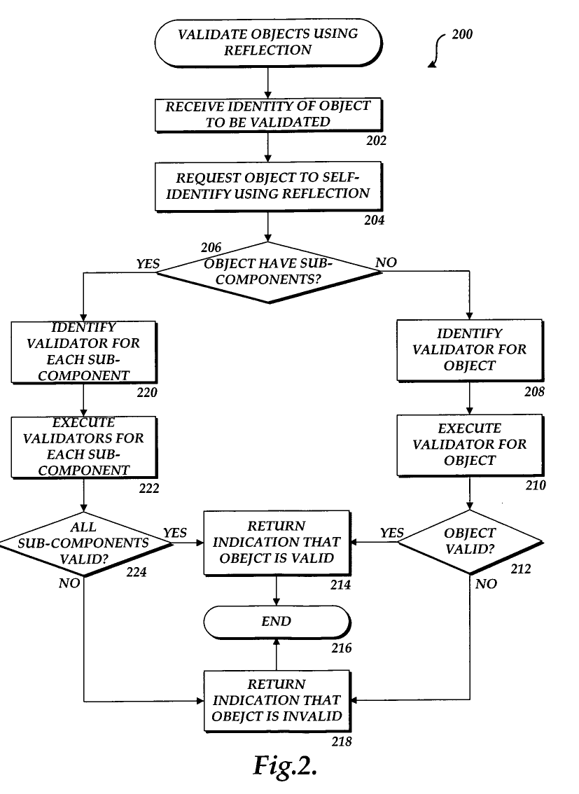

As will be discussed in greater detail below, the validation engine 102 utilizes reflection to determine one or more structural or behavioral characteristics of an object or sub-component of an object. The obtained characteristics are then utilized to identify a policy file 112 in the policy library 110 and, correspondingly, the appropriate validator 116 for validating the object. The validation engine 102 then executes the identified validator 116 to validate the object. Additional details regarding this process are provided below with respect to FIG. 2.

In one embodiment, the data object 108 is a component manifest. A component manifest is an XML document that describes the binaries, settings, and declared dependencies of a component within the MICROSOFT® .NET FRAMEWORK™. In this embodiment, one or more validators 116 are configured for validating the contents of a component manifest.

Referring now to FIG. 2, additional details will be provided regarding the embodiments presented herein for dynamically validating an object using reflection. In particular, FIG. 2 is a flow diagram showing a routine 200 that illustrates the operation of a computer 300, described below, for dynamically validating a software object 104 or a data object 108 using reflection.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination. It should also be appreciated that more or fewer operations may be performed than shown in FIG. 2 and described herein. These operations may also be performed in a different order than those described herein with respect to FIG. 2.

The routine 200 begins at operation 202, where the validation engine 102 receives the identity of a software object or data object to be validated. As described above, the validation engine user interface program 118 or a script 120 may be utilized to indicate to the validation engine 102 which object or objects should be validated. From operation 202, the routine 200 continues to operation 204 where the validation engine 102 requests the object that is to be validated to identify its characteristics using reflection. If the object has sub-components, each of the sub-components may also be requested to identify their characteristics through reflection. Once the characteristics of the object and its sub-components, if any, have been identified through reflection, the routine 200 continues from operation 204 to operation 206.

At operation 206, the validation engine 102 determines whether the object to be validated has sub-components. If the validation engine 102 determines that the object to be validated does not have sub-components, the routine 200 proceeds from operation 206 to operation 208. At operation 208 the validation engine 102 identifies the appropriate validator 116 for the object to be validated. As described above, in order to identify the appropriate validator, the validation engine 102 utilizes the characteristics obtained from the object using reflection to search the policy library 110 for a policy file 112 corresponding to the obtained characteristics. A policy file 112 that includes the returned structural or behavioral characteristics also includes a reference to the proper validator 116 for validating the object.

Once the proper validator 116 has been identified for the object, the routine 200 continues to operation 210 where the validation engine 102 executes the identified validator 116 to validate the object. Once the validator 116 has completed its processing, the routine 200 proceeds to operation 212 where the validation engine 102 determines whether the validator concluded that the object is valid. If so, the routine 200 proceeds from operation 212 to operation 214 where an indication is returned that the object is valid. If not, the routine 200 proceeds from operation 212 to operation 218, where an indication is returned that the object is invalid. As discussed above with reference to FIG. 1, the validation engine user interface program 118 or the results file 122 may be utilized to communicate the results of the validation process to a user. From operations 214 and 218, the routine 200 proceeds to operation 216, where it ends.

If the validation engine 102 determines at operation 206 that the object to be validated has sub-components, the routine 200 proceeds from operation 206 to operation 220. At operation 220, the appropriate validator for each sub-component 106 is determined by searching the policy library in the manner described above. Once the appropriate validators 116 for each sub-component 106 have been identified, the routine 200 continues to operation 222 where the validators 116 for each of the sub-components 106 are executed.

After the validators 116 have completed their execution, the routine 200 proceeds to operation 224 where the validation engine 102 determines whether each of the sub-components 106 was determined to be valid by its respective validator 116. If so, the routine 200 proceeds from operation 224 to operation 214, where an indication is returned indicating that the entire object is valid. Otherwise, the routine 200 proceeds from operation 224 to operation 218, where an indication is returned indicating that the object is invalid. Results may also be returned regarding the validity of each of the sub-components. From operations 214 and 218, the routine 200 continues to operation 216, where it ends.

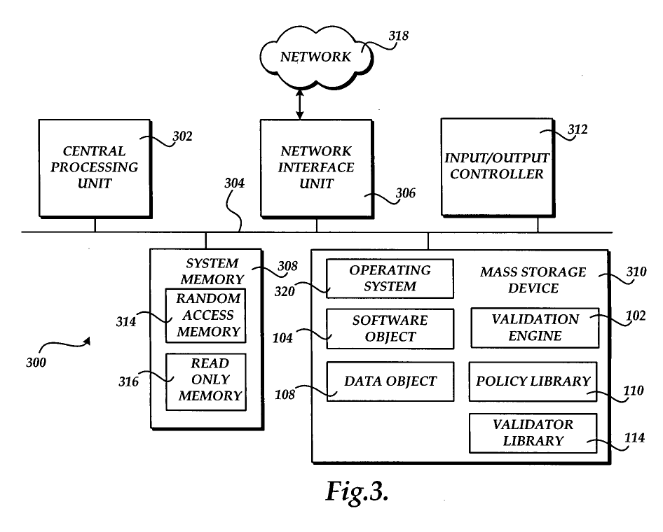

Referring now to FIG. 3, an illustrative computer architecture for a computer 300 capable of executing the software components described above with respect to FIGS. 1 and 2 will be discussed. The computer architecture shown in FIG. 3 illustrates a conventional desktop, laptop computer, or server computer. The computer architecture shown in FIG. 3 includes a central processing unit 302 (“CPU”), a system memory 308, including a random access memory 314 (“RAM”) and a read-only memory (“ROM”) 316, and a system bus 304 that couples the memory to the CPU 302. A basic input/output system containing the basic routines that help to transfer information between elements within the computer 300, such as during startup, is stored in the ROM 316. The computer 300 further includes a mass storage device 310 for storing an operating system 320, application programs, and other program modules, which will be described in greater detail below.

The mass storage device 310 is connected to the CPU 302 through a mass storage controller (not shown) connected to the bus 304. The mass storage device 310 and its associated computer-readable media provide non-volatile storage for the computer 300. Although the description of computer-readable media contained herein refers to a mass storage device, such as a hard disk or CD-ROM drive, it should be appreciated by those skilled in the art that computer-readable media can be any available media that can be accessed by the computer 300.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 300.

According to various embodiments, the computer 300 may operate in a networked environment using logical connections to remote computers through a network 318, such as the Internet. The computer 300 may connect to the network 318 through a network interface unit 306 connected to the bus 304. It should be appreciated that the network interface unit 306 may also be utilized to connect to other types of networks and remote computer systems. The computer 300 may also include an input/output controller 312 for receiving and processing input from a number of other devices, including a keyboard, mouse, or electronic stylus (not shown in FIG. 3). Similarly, an input/output controller may provide output to a display screen, a printer, or other type of output device (also not shown in FIG. 3).

As mentioned briefly above, a number of program modules and data files may be stored in the mass storage device 310 and RAM 314 of the computer 300, including an operating system suitable for controlling the operation of a networked desktop, laptop, or server computer. The mass storage device 310 and RAM 314 may also store one or more program modules. In particular, the mass storage device 310 and the RAM 314 may store the validation engine 102, policy library 110, validator library 114, software object 104, and data object 108, described above with reference to FIGS. 1 and 2. Other program modules may also be stored in the mass storage device 310 and utilized by the computer 300.

Based on the foregoing, it should be appreciated that technologies for dynamically validating an object through the use of reflection are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for validating an object, the method comprising:
identifying one or more characteristics of the object using reflection;
using the characteristics to identify a validator capable of validating the object; and
executing the validator to validate the object.

2. The method of claim 1, wherein the object comprises a data object.

3. The method of claim 2, wherein the data object comprises a component manifest.

4. The method of claim 1, wherein the object comprises a software object.

5. The method of claim 1, wherein using the characteristics to identify a validator capable of validating the object comprises:
searching a policy library for a policy file corresponding to the characteristics; and
in response to locating a policy file corresponding to the characteristics, identifying the validator for validating the object from data stored in the policy file.

6. The method of claim 4, wherein the validator is stored in a validator library.

7. A computer-readable medium having computer-executable instructions stored thereon which, when executed by a computer, cause the computer to:
receive an identity of an object to be validated;
determine one or more characteristics of the object to be validated through reflection;
select a validator capable of validating the object by searching a policy library for a policy file referencing the characteristics; and to
execute the validator to validate the object.

8. The computer-readable medium of claim 7, wherein the object comprises a software object.

9. The computer-readable medium of claim 7, wherein the object comprises a data object.

10. The computer-readable medium of claim 7, wherein the object comprises two or more sub-components.

11. The computer-readable medium of claim 10, wherein determining one or more characteristics of the object to be validated through reflection comprises determining one or more characteristics of each of the sub-components through reflection.

12. The computer-readable medium of claim 11, wherein selecting a validator capable of validating the object by searching a policy library for a policy file referencing the characteristics comprises selecting a validator capable of validating each sub-component by searching a policy library for a policy file referencing the characteristics of a sub-component.

13. The computer-readable medium of claim 12, wherein executing the selected validator to validate the object comprises executing the validators for each of the sub-components to validate the object.

14. The computer-readable medium of claim 13, wherein the object is valid if each of the sub-components is valid.

15. A method for validating an object having two or more sub-components, the method comprising:
identifying one or more structural or behavioral characteristics for each of the sub-components using reflection;
for each sub-component, using the characteristics to identify a validator capable of validating the sub-component; and
executing the validator for each sub-component to validate the object.

16. The method of claim 15, wherein the object comprises a software object.

17. The method of claim 15, wherein the object comprises a data object.

18. The method of claim 15, wherein the object is valid if each sub-component is determined to be valid.

19. The method of claim 15, wherein identifying a validator capable of validating each sub-component comprises:
searching a policy library for a policy file corresponding to the characteristics for each sub-component; and
in response to locating a policy file corresponding to the characteristics for a sub-component, identifying the validator for validating the sub-component from data stored in the policy file.

20. The method of claim 19, wherein each validator is stored in a validator library.
